(19) United States
(12) Patent Application Publication
(10) Pub. No.: US 2011/0082771 A1
(43) Pub. Date: Apr. 7, 2011

(54) SYSTEM AND METHOD FOR PRODUCT PURCHASE AND DISTRIBUTION THROUGH COMPUTER NETWORK INTERFACE

(76) Inventors: Scott Pritikin, San Francisco, CA (US); Elise Papazian, San Francisco, CA (US)

(21) Appl. No.: 12/573,049

(22) Filed: Oct. 2, 2009

(51) Int. Cl. G06Q 30/00; G06F 3/048; G06Q 20/00

(52) U.S. Cl. 705/27.1; 715/760; 715/769

(57) ABSTRACT

The method and system of the present invention represents an online internet ordering, fulfillment and shipping process that enables internet consumers to utilize a novel purchasing interface that is easily employed and modified. The system provides a user with an advanced purchasing queue that allows the purchaser to select items to be purchased by placing the items in a series of carts that are all placed in a purchasing queue. Once the series of carts are placed in a queue, the purchaser can select order of completion and also select the time period for each cart to be executed. Once activated, the purchasing queue is automatically initiated, and each cart is executed in the priority as set up by the user. A user may also be given the option to request that the purchasing queue continue indefinably, making shipments in accordance with the placement of the order and shipment carts within the queue. Also, the user may be provided with the option to place the queue on hold, until deleted or resumed at a later date. Furthermore, the interface of the system and method of the present invention provides a graphical interface that allows the user to drag and drop the order and shipment carts within the queue to change their placement within the queue and therefore the shipment priority.

### STATEMENT RE: FEDERALLY SPONSORED RESEARCH/DEVELOPMENT

Not Applicable

### CROSS-REFERENCE TO RELATED APPLICATIONS

Not Applicable

### BACKGROUND

The present invention relates to a computer implemented method and system for ordering and purchasing items through a network, and more particularly over the Internet.

The online purchasing of goods and services through computers interconnected to the worldwide web, also known as the internet has become common place to both businesses and consumers. A remote user computer accesses the internet through a web browser to view a webpage through a hypertext transfer protocol (“HTTP”) request. A request is communicated to a web server that supports the webpage, and the user computer is able to view the webpage locally on a browser.

In e-commerce websites it is typical to provide a listing of products available for purchase on a webpage. A user can identify, through a search request or other means to locate a product to be purchased, and the user can click through a link for a listed item to obtain more detailed information about the product, including quality, dimension, color, appearance, pricing, availability and other pertinent information. The available products can be analogized as an online catalog or an online store shelf. The selection and purchase of product on a typical e-commerce website regularly use a “shopping cart” arrangement. When the purchaser identifies and selects an item from the website a server computer adds that item to a “shopping cart” where that single item, or other items are pooled together so that the user may continue shopping while the server remembers the previously selected items. When the purchaser has finished “shopping” the user calls a listing of items that are in the “shopping cart” which provides a graphical interface for the user to “checkout”. In many instances once the user selects the “checkout”, the user is then prompted to enter payment information and shipment information, verifying and completing the transaction. While the “shopping cart” model is widely used the information provided in the “shopping cart” is typically static and is nothing more than a transition webpage between the selection of the items to the ultimate end purchase. A background discussion of “shopping cart” interfaces used in ecommerce websites may be found at U.S. Pat. No. 7,222,087, the entire substance of which of is incorporated herein by reference.

While the “shopping cart” arrangement is intuitive for web purchases, it is modeled primarily upon a brick and mortar type purchase where a purchaser collects items throughout the store and exits the store through a single transaction. Internet webpages, however, are capable of providing much more complicated and ongoing purchasing arrangements between the retailer and the consumer. For example, consumers may desire to purchase items on an ongoing basis and include more complex shipping instructions. Under these circumstances, the traditional “shopping cart” arrangement may be unsuitable and cumbersome for both the retail sales provider and the consumer, particularly for repeat or ongoing purchases. As such, there is a great need in the art for a system and method for a user friendly purchasing arrangement that effects continuing automatic purchases and automatic shipments and also allows the consumer to modify purchasing requests after submitted and to arrange and modify information within the “shopping cart” to suit the ongoing relationship between the retail web provider and the consumer.

### BRIEF SUMMARY

An embodiment of the present invention provides a computer implemented method and system for ordering and purchasing items through a network, and more particularly over the Internet. The method of the present invention is employed in an internet or network setting utilizing a web server accessible by a one or more remote computers. On the back end of the server one or more product suppliers through remote computers connected to the internet provide item information to a server database wherein information placed in said supplier database is used for website content to provide information on items to be purchased on the webpage. Suppliers can also access the server to receive requests for product order fulfillment. In the embodiment described herein, suppliers offer whole and ground coffee bean products, however, it is contemplated that any number of different products can be offered for purchase. On the front end of the sever, users such as individual or business consumers access the website to identify, order, purchase and receive shipment of the items being sold.

The method and system of the present invention represents an online internet ordering, fulfillment and shipping process that enables internet consumers to utilize a novel purchasing interface that is easily employed and modified. The system provides a user with an advanced purchasing queue that allows the purchaser to select items to be purchased by placing the items in a series of carts that are all placed in a purchasing queue. Once the series of carts are placed in a queue, the purchaser can select order of completion and also select the time period for each cart to be executed. Once activated, the purchasing queue is automatically initiated, and each cart is executed in the priority as set up by the user. For example, a user may select five separate items, and place each item into separate order shipment carts. The user can select a one week interval between shipments and can even identify the first shipment date. Thereafter, once active, the purchase queue of the present invention will execute a purchase and shipment order at one week intervals for a period of five weeks. After that time, unless modified by the consumer, the orders and shipments will cease.

In the above example, a user may also be given the option to request that the purchasing queue continue indefinitely, making shipments in accordance with the placement of the order and shipment carts within the queue. Also, the user may be provided with the option to place the queue on hold, until deleted or resumed at a later date. Furthermore, the interface of the system and method of the present invention provides a graphical interface that allows the user to drag and drop the order and shipment carts within the queue to change their placement within the queue and therefore the shipment priority. The flexibility of the system provides an inviting and engaging purchasing system that allows a customer to place product orders near or far in the future, and the customer can set the purchases up and receive shipment over time without the bother of repeat shipment orders and requests. The system is available from any internet connection, employing user friendly graphics that allow a user to easily change the order of the items already ordered, modify the shipment specifics such as number of items shipped, delete shipments or place shipments on hold.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a screenshot of a user interface for setting up a user purchasing queue.

FIG. 2 is a screenshot of a user interface showing an example of purchasing queue of listed products.

FIG. 3 is a screenshot showing an example of a listed item for purchase.

FIG. 4 is a screenshot of a user interface showing an a listing of products to be purchased identifying top sellers.

FIG. 5 is a screenshot of a user interface showing a listing of several items for purchase.

FIG. 6 is a screenshot of a user interface showing an example of purchasing queue of listed products.

FIG. 7 is a screenshot of a user interface showing an example of purchasing queue of listed products.

FIG. 8 is a screenshot of a user interface showing an example of purchasing queue of listed

FIG. 9 is a screenshot of a user interface showing an example of purchasing queue of listed products, demonstrating how items are added.

FIG. 10 is a screenshot of a user interface showing an example of purchasing queue of listed products.

FIG. 11 is a screenshot of a user interface showing an example of purchasing queue of listed products.

FIG. 12 is a screenshot of a user interface showing an example of purchasing queue of listed products.

FIG. 13 is a screenshot of a user interface showing an example of purchasing queue of listed products.

FIG. 14 is a screenshot of a user interface for setting up a user purchasing queue.

FIG. 15 is a screenshot of a user interface for setting up a user purchasing queue.

FIG. 16 is a screenshot of a user interface for setting payment options.

FIG. 17 is a screenshot of a user interface for setting up a user purchasing queue.

FIG. 18 is a screenshot of a user interface for setting up a user purchasing queue.

FIG. 19 is a screenshot of a user interface for setting up a user purchasing queue.

FIG. 20 is a screenshot of a user interface showing an example of purchasing queue of listed products.

FIG. 21 is a screenshot of a user interface for setting up a user purchasing queue.

FIG. 22 is a screenshot of a user interface for setting up a user purchasing queue.

FIG. 23 is a screenshot of a user interface showing an example of purchasing queue of listed products.

FIG. 24 is a screenshot of a user interface for setting up a user purchasing queue.

FIG. 25 is a screenshot of a user interface showing an example of purchasing queue of listed products.

FIG. 26 is a screenshot of a user interface for setting up a user purchasing queue.

FIG. 27 is a screenshot of a user interface showing an example of purchasing queue of listed products.

FIG. 28 is a screenshot of a user interface for setting up a user purchasing queue.

FIG. 29 is a screenshot of a user interface for setting payment options.

FIG. 30 is a screenshot of a user interface showing an example of purchasing queue of listed products.

FIG. 31 is a diagram of the system including an embodiment of the present invention.

FIG. 32 is a flow diagram of a routine which processes the order and purchasing items over the internet as described by the present invention.

FIG. 33 represents a screenshot interface for use by suppliers of items.

FIG. 34 represents a screenshot interface for use by suppliers of items.

FIG. 35 represents a screenshot interface for use by suppliers of items.

FIG. 36 represents a screenshot interface for use by suppliers of items.

FIG. 37 represents a screenshot of a manage account screen used by supplier of items.

FIG. 38 represents a screenshot of accounting information used by an administrator of the website.

### DETAILED DESCRIPTION

The present invention provides a method and system for ordering and purchasing items through a network, and more particularly over the Internet using computers.

The embodiment of the present invention provides a computer implemented method and system for ordering and purchasing items through the Internet. The method and system of the present invention represents an online Internet ordering, fulfillment and shipping process that enables Internet consumers to utilize a novel purchasing interface. The process allows the customer to place product orders on a repeated and ongoing basis which minimizes the order management time on the part of the user as well as the website administrator.

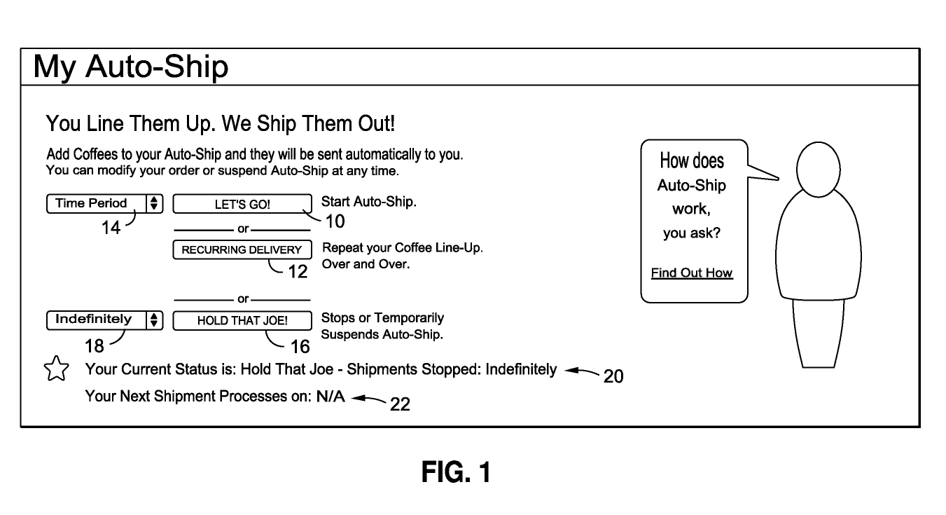

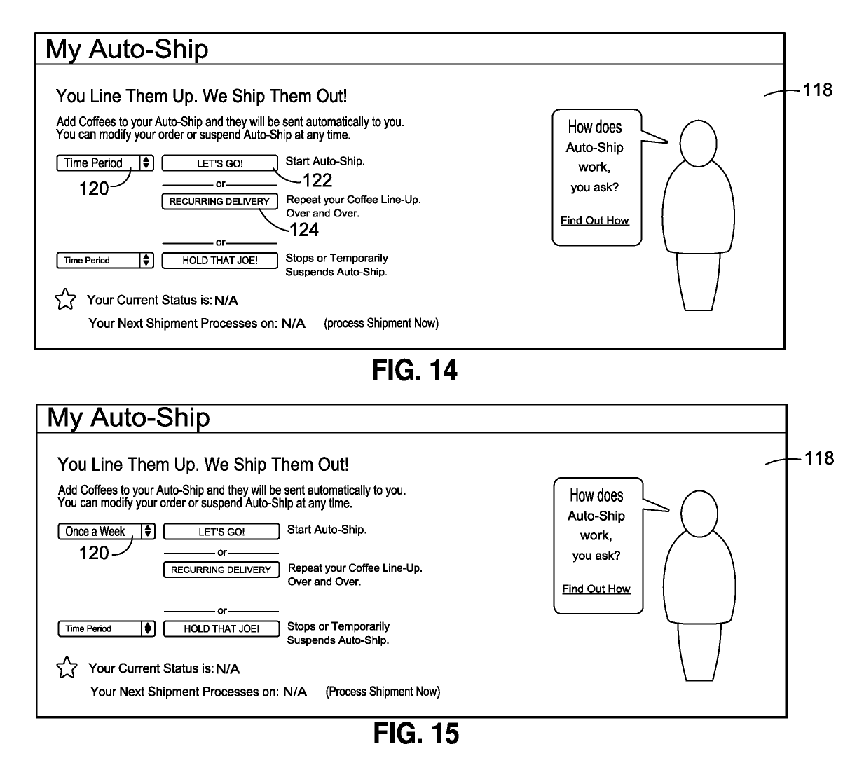

Referring particularly to FIG. 1, there is shown an example of a screenshot of a opened user interface that allows the user to setup automatic shipment of product. The setup screen as shown in FIG. 1 provides a button 10 that initiates the automatic shipment process. The user has the option of selecting between the auto shipment 10 or a reoccurring delivery button 12 which will repeat the auto shipment on an ongoing basis. Further, a time period selection drop down button 14 is also provided for the user to designate the frequency or time periods between automatic shipments. A further option is provided by button 16 that stops or temporarily suspends the auto shipment. The auto shipment suspension can be implemented for a chosen time period through the drop down button 18. A status line 20 also provides the user with information regarding the current status of the auto shipment. Further, a process date line 22 is additionally provided to indicate the date of the next shipment. A more detailed discussion regarding the activation of the auto shipment and using of the open interface as shown in FIG. 1 is described in greater detail with respects to FIGS. 14-28 below.

Product Selection

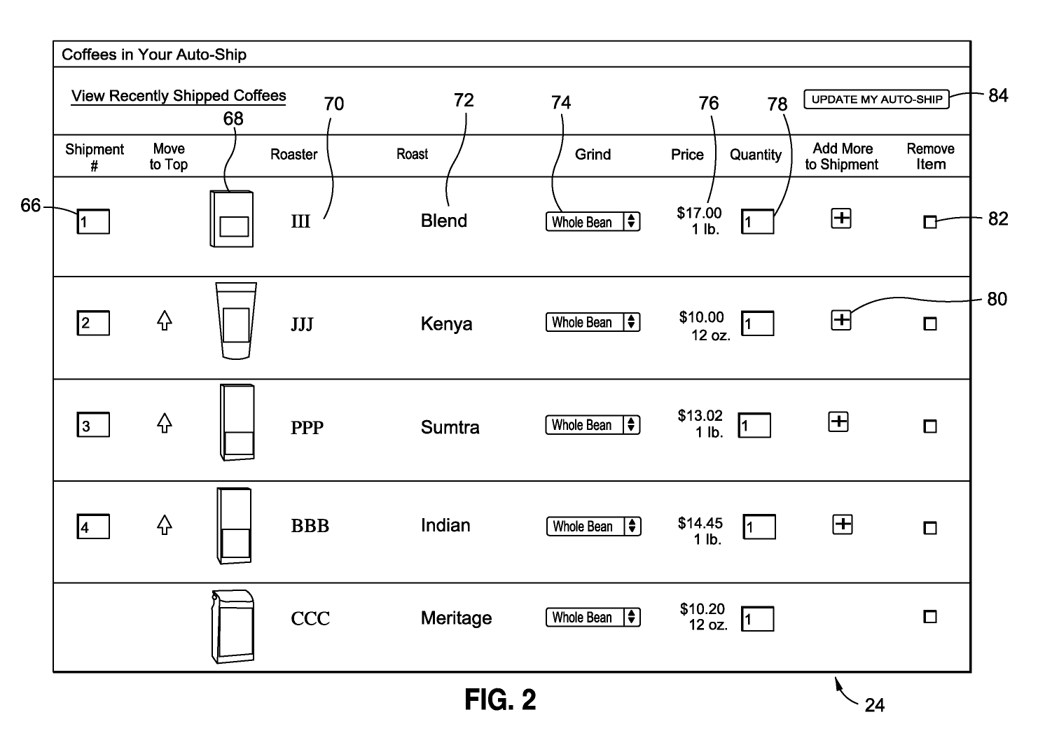

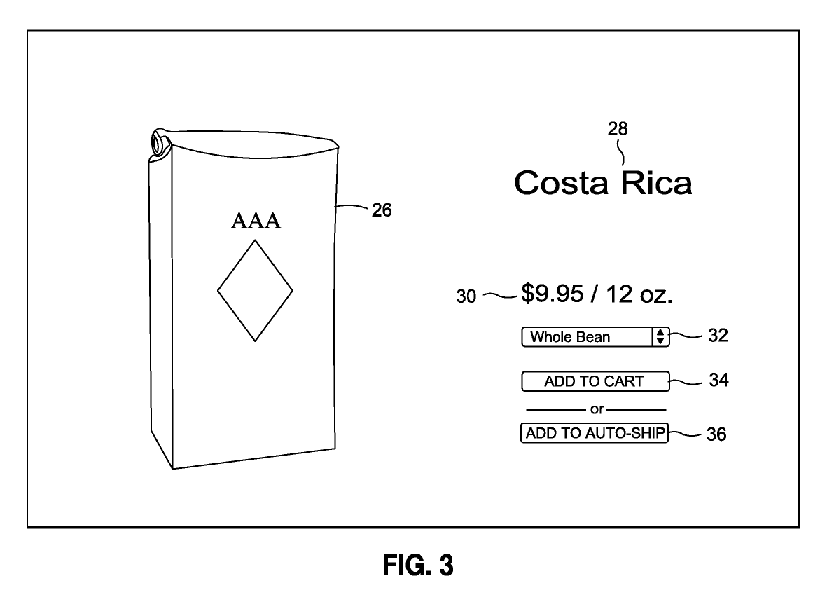

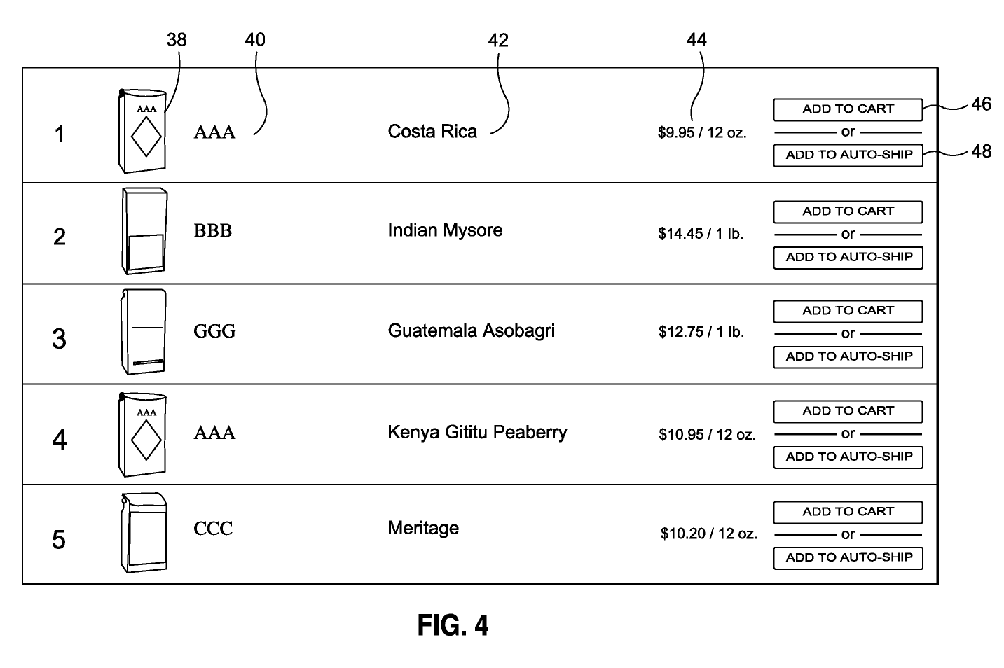

Referring particularly to FIGS. 2 through 6, the operation for populating items into a purchasing queue 24 is shown. The customer accesses the website through the Internet to display the website on the user's browser. The user can browse through a series of items on the website to determine which items the user wishes to purchase. In the embodiment of the present invention, the items provided are whole bean and ground coffee, however, any suitable item may be displayed and purchased on the website. An individual product may be identified and viewed by the user as shown in FIG. 3. A photograph of an item 26 may be displayed on the individual product page as shown in FIG. 3, or alternatively a written description may be provided. Typically, the product page may include an identification of the product name 28 as well as product pricing 30. The user will have access to the drop down product specification button 32 which in this case the user can select between a whole bean or ground coffee. Then the user has the option of adding the product to a traditional style shopping cart through the button 34 or adding the product to the purchasing queue through the add to automatic shipment button 36. The ability to select to adding to the purchasing queue through the button 36 instead of the typical add to cart button 34 enables the user the option to have a product purchased, shipped and delivered on a time table when the customer chooses. A screen interface is shown as a partial screen shot in FIG. 4 which provides alternate ways of displaying products to be purchased. For example, in the menu of items shown in FIG. 4 the items are displayed in a list format and in this particular example identify the top five selling products. The abbreviated display of the product is shown, and includes, for example, a picture of the product 38, identification is the manufacture 40, the product name 42, pricing information 44, an add to cart button 46 and the add to auto shipment button 48. The user can add the product to a cart or an auto shipment queue directly from the menu as shown in FIG. 4 or alternatively the user may click on the picture 38 to pull up a more detailed view of the product such as shown in FIG. 3.

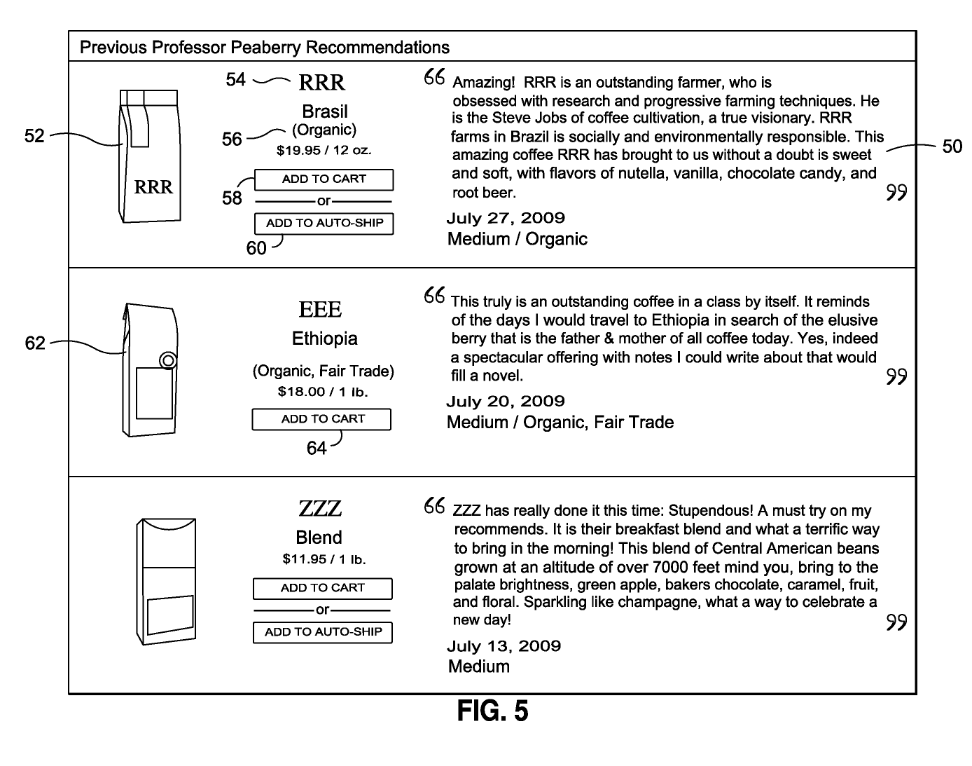

A further example of a page displaying a menu of items as shown in FIG. 5. In this example a menu of recommendation items are provided, and additionally includes a written description 50 provided by the person or entity recommending the product. Again, the menu provides a photo or graphical representation of the product 52, a product name 54, pricing information 56, an add to cart button 58 and add to automatic shipment button 60. Furthermore, for a number of reasons, certain of the items that are available for sale on the website may not be suitable for recurring purchases and as such, as is shown in the center product listing of the example in FIG. 5, the eco-café product 62 does not include a “add to auto shipment” button, and as such, may only be purchased directly through an add to cart button 64. Whether or not a product can be purchased by auto shipment is at the discretion of the website administrator and therefore certain products may or may not be designated for auto shipment.

Once the products have been selected and placed into the auto shipment queue, the user can then open the interface on the webpage that shows the products placed into the auto shipment queue 24 as shown in FIG. 2. Each order shipment is identified by a shipment number, as shown in box 66, the shipment number designating the priority of the shipment. For example, in the product queue 24 the first shipment to be filled is shown at the top of the queue as shipment no. 1. Upon fulfillment of shipment no. 1, the product identified therein is removed from the queue and each of the products move up in priority in the shipment queue. From the shipment queue, the user can identify a picture or graphical representation 68 of each of the products with a identification of the roaster 70, the type of roast 72 the specifics of the ordered items 74, and in this example, whether the item is whole bean or ground. The quality selection 74 button enables the user to change the item from whole bean to ground directly within the auto ship queue. A price 76 is provided along with the quantity of the items 78. The plus button 80 allows a user to add additional products to the shipment. An item may be removed by checking the box 82 and then clicking on the box to update the auto shipment 84.

Add to Automatic Shipment

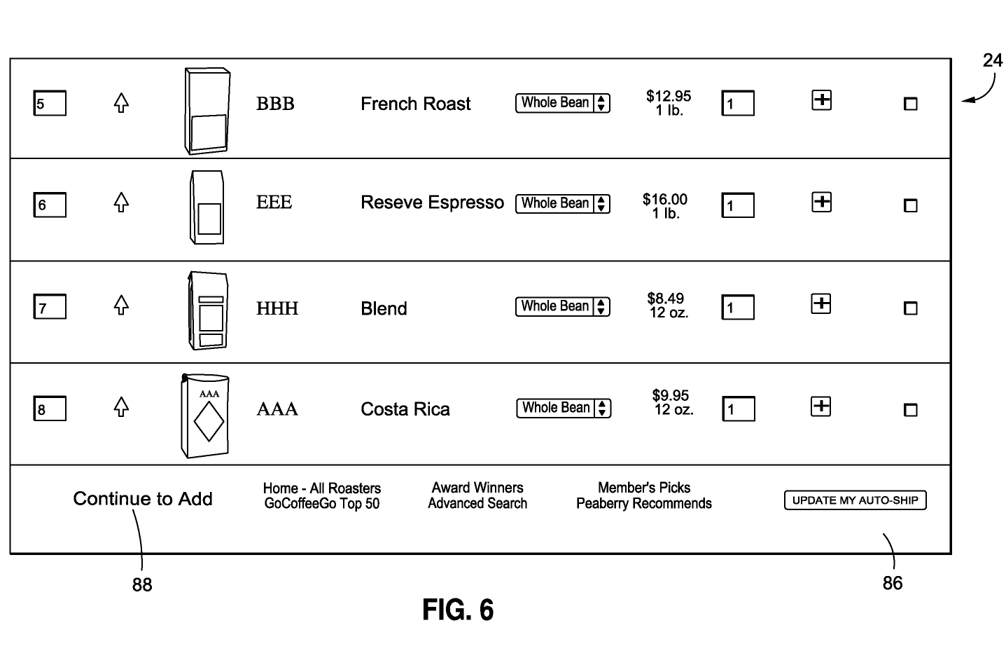

Referring particularly to FIG. 6, there is shown a purchasing queue 24 of the present invention which shows a link bar 86 that is found at the bottom of the queue 24. The link bar 86 provides the customer with the choice of different links to continue to add more items for purchase and shipment. The inclusion of the links allows the customers to easily continue to shop by clicking on the links at the bottom of the queue 24, pulling up additional items to view, and the customer can then add more items to the auto shipment queue 24. For example, a “continue to add” link 88 returns the user to the last location they were visiting on the website. Other links on the link bar 86 can include a link to the homepage, to the top fifty items, to award winning products, to an advance search, to the members picks, as well as a link to recommendations. Any number of suitable links may be included to the queue 24 to allow the user the flexibility to add additional products to the queue. Further, although the link bar 86 is found at base of the queue 24, the bar may be positioned at a variety of places around or within the queue 24.

Moving Shipments

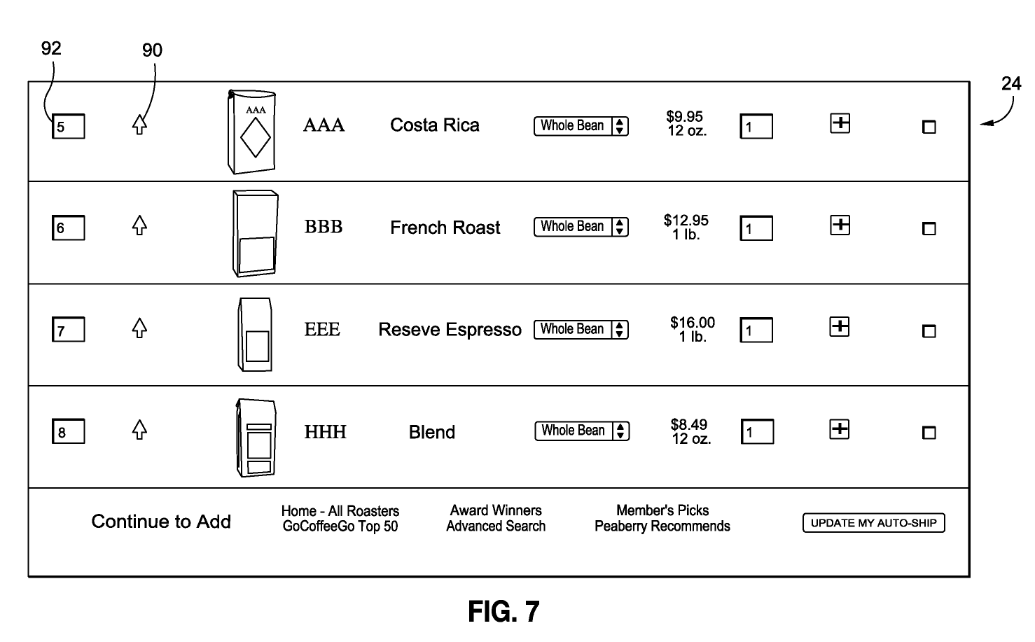

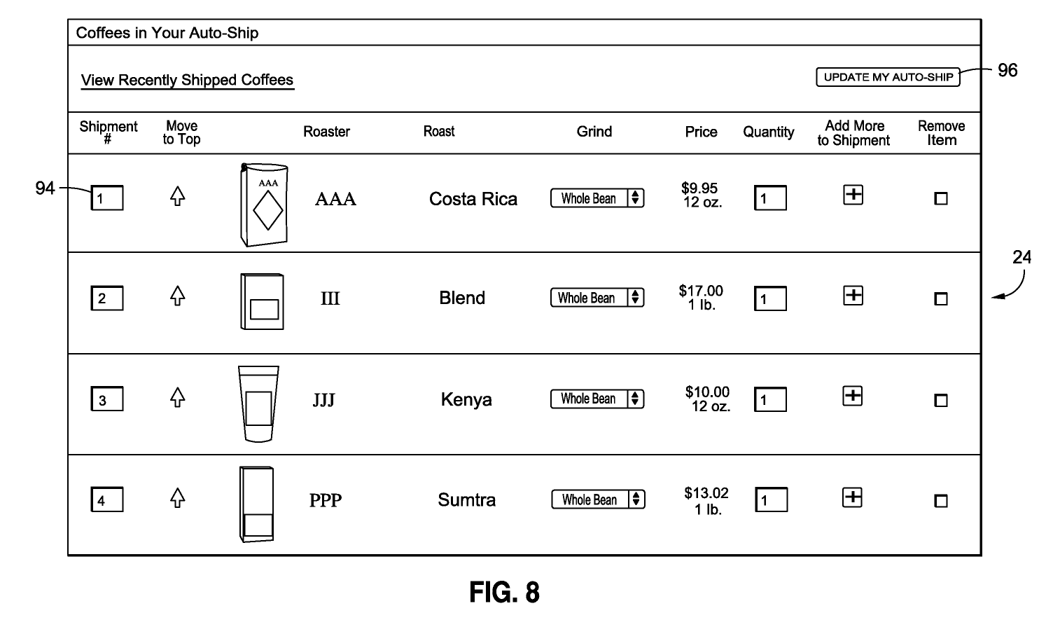

Referring particularly to FIGS. 7 and 8, in the embodiment of the present invention, the shipment queue 24 provides the ability to easily drag and drop an entire shipment entry into a new position within the queue 24. By clicking anywhere on a shipment bar (except on the product icon itself) a user can drag the entire shipment up or down and drop it into a new position. The shipment number as shown, for example, in box 90 at shipment priority no. 5 as shown in FIG. 7, is then automatically updated based upon the new position. Also by clicking on the arrow 92 of the queue 24 as shown in FIG. 7 the entire shipment bar floats above the other bars and slides them up to the top number 1 position 94 as shown in FIG. 8. The box 94 automatically updates based on the new location and placement of the shipment bar. Items may also be moved by changing the shipment number for example in box 94 to a number available in the current queue on the left and clicking “update” button 96 as shown in FIG. 8 and the shipment bar will relocate to the desired position. Also, multiple items can be moved in a single click by assigning new numbers within the box 94 (and in several of the other boxes) and click update 96 and all the shipments will be relocated to the desired position. As shown in FIGS. 7 and 8, the queue 24 provides three ways of moving the shipment carts within the queue 24, namely clicking on the shipment bar and dragging and dropping to place in a new location, by clicking on the arrow 92 to move the shipment bar to the number 1 position and by changing the number for example in box 90 to available number in the queue and updating the auto ship 96 to relocate the shipment cart.

Add Item to an Existing Shipment

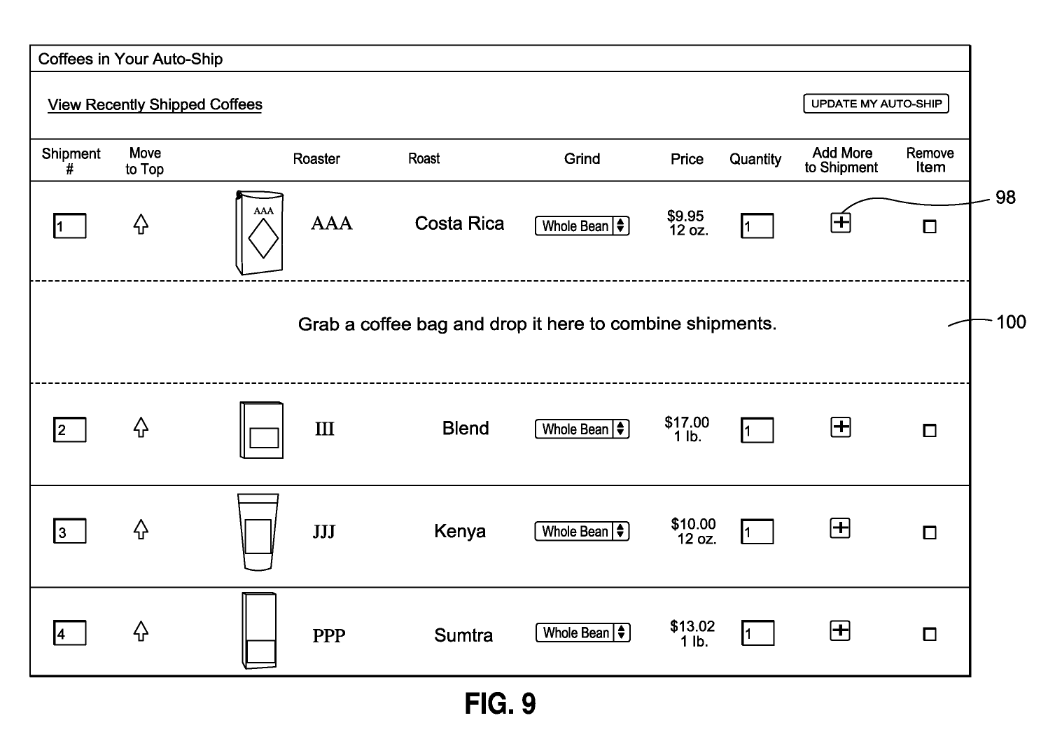

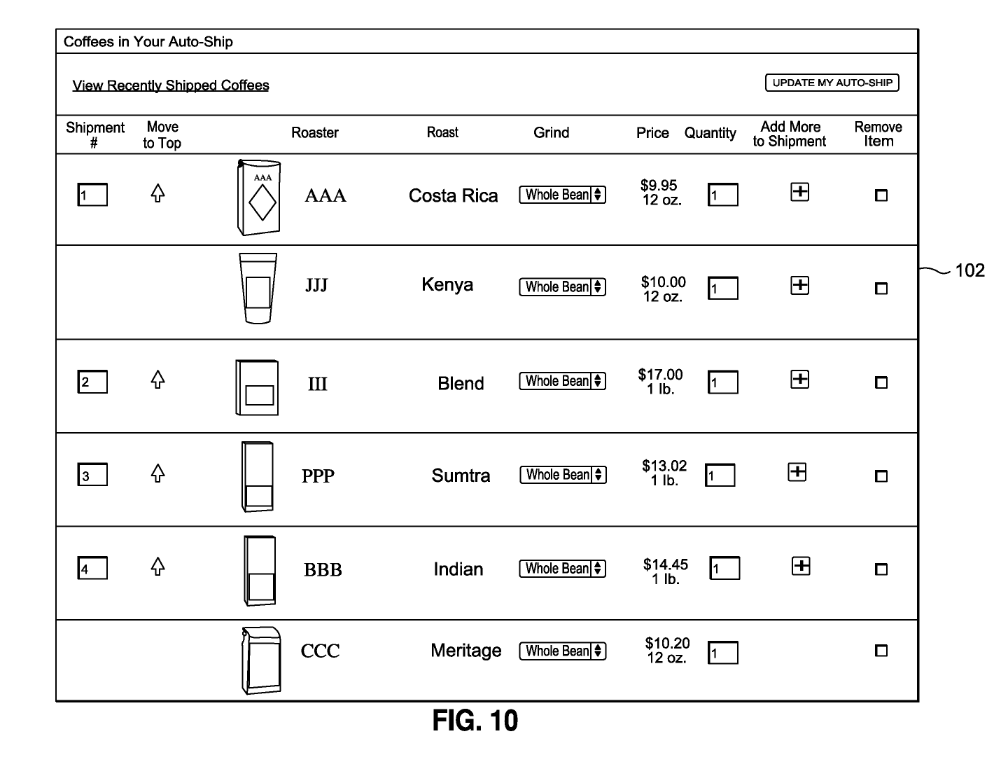

Referring particularly to FIGS. 9 and 10 the item purchasing and ordering system of the present invention, a user may click on the plus icon 98 on the shipment bar to “add more to shipment”. When the plus icon 98 is clicked, a shipment bar opening 100 appears below the shipment bar that included the icon 98. In typical operation, the bar would, in visual size on the computer screen, approximate a shipment cart bar and would be visually offset via shading or other visual means. A message within the shaded box can state “grab a coffee bag and drop it here to combine shipments”. A user would be allowed to click on a shipment line that slides and floats over the other shipments, an example of FIG. 9 shipment no. 3 “Johnson's Brothers” is dragged and dropped onto the combined shipment lines 100. The dragging and dropping is implemented by simply clicking the mouse and holding the mouse button in while the item is dragged and when the mouse button is released it is dropped into place into the drop shipment line 100. The result is shown in FIG. 10 where the Johnson's Brothers shipment is included within shipment no. 1 as shown in 102. As shown in the example of FIG. 10 shipment 102 provides shipments from two vendors. In the case where there are multiple vendors, once the shipment is executed, the individual vendors would be notified of the order in separate order queues on the back end of the website through the supplier interface (not shown).

To Remove an Item

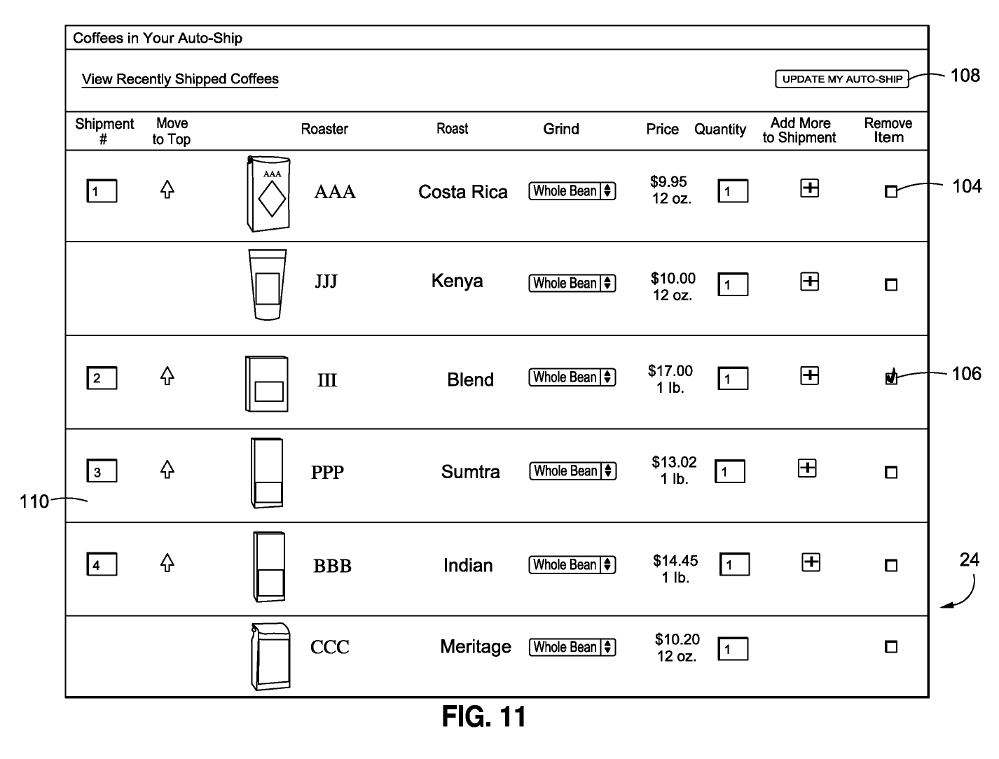

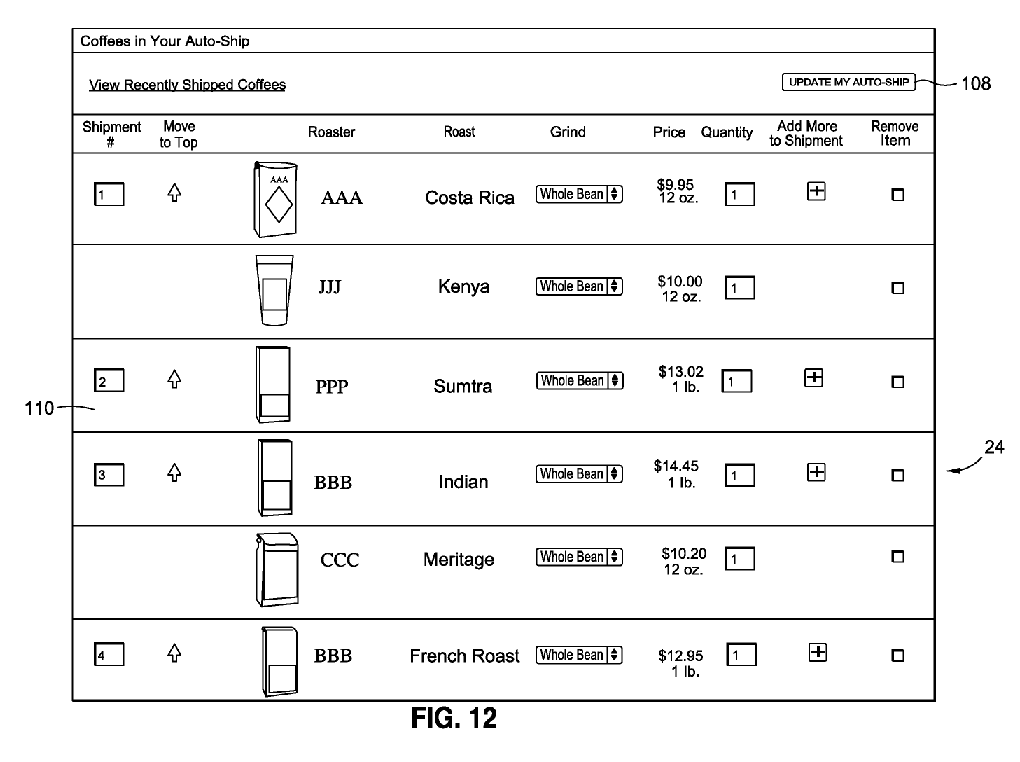

Referring particularly to FIGS. 11 and 12 a user can remove one or multiple items from the queue 24 from within each of the shipment bars by a toggle box 104. In the example of FIG. 11, a box 106 is checked. The user then selects the “update” 108 button and the selected shipment bar is removed from the queue 24 as is shown in FIG. 12. Each of the shipment bars are then shifted up in priority, and in the example of FIGS. 11 and 12, a shipment bar is moved form the no. 3 position in FIG. 11 to the no. 2 position as shown in FIG. 12. User can also remove multiple items from the queue 24 by selecting multiple boxes and selecting the “update” button 108. The items will shift upwardly based on the shipments that were removed from the queue 24.

To Change Item Attributes

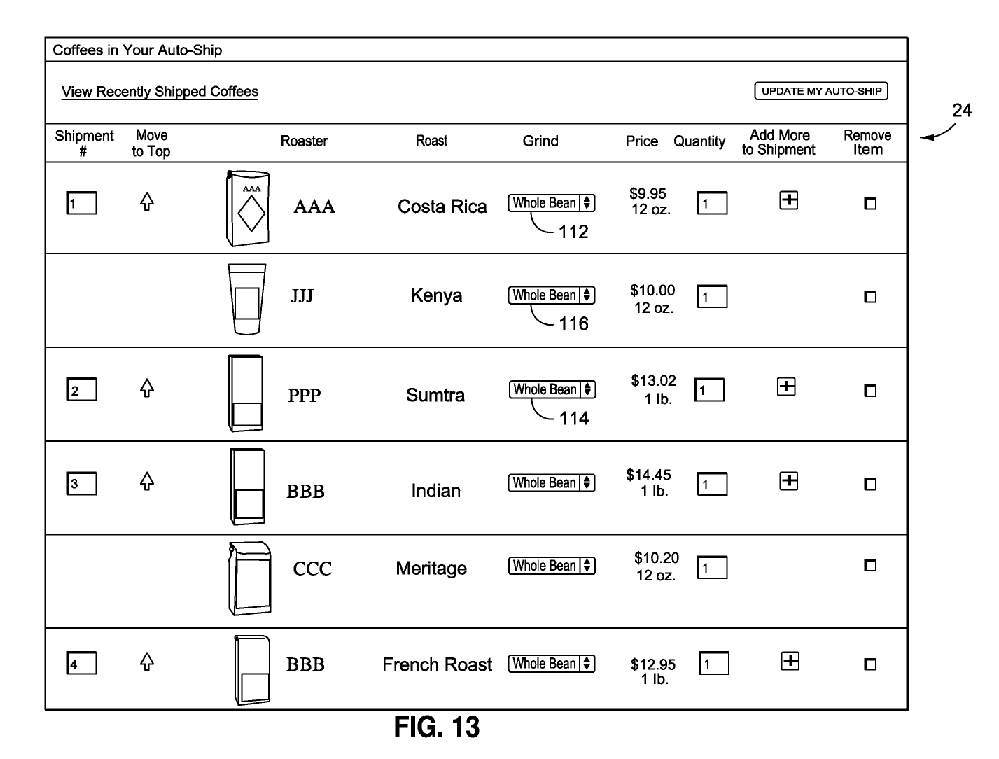

Referring particularly to FIG. 13, there is shown an example of a shipment queue 24. To select a particular attribute of an item and in this example “the grind” choice column, a user will select the choice on a drop down button 112 to change the attributes of an item. Although this specific example provides a choice between “whole bean” or “French press” it is contemplated by the present invention that different types of items may be utilized in different types of attributes may be provided for selection. The attribute selection is carried over from the individual product page and the attributes may be different for each particular item. Furthermore, items made available on “top seller” pages or other types of listings where products can be added to the automatic shipment queue 24, specific attributes may not be available. The attribute choices may be automatically updated by activity such as clicking other links, moving to a next page or leaving the website altogether and therefore it is not required to use the “update” button to update the attribute. In the example of FIG. 13, in shipment position no. 1 the dropdown button 112 is selected to “whole bean” and shipment no. 2 dropdown button 114 is set to “French press”. In the shipment no. 1, which includes two separate items, one dropdown button 112 can be selected as “whole bean” and another dropdown button for a different product 116 could be either “whole bean” or “French press”. There is no requirement that the attribute are the same in a single shipment. The attribute is selected solely with respect to each item.

Initial Activation of Automatic Shipment

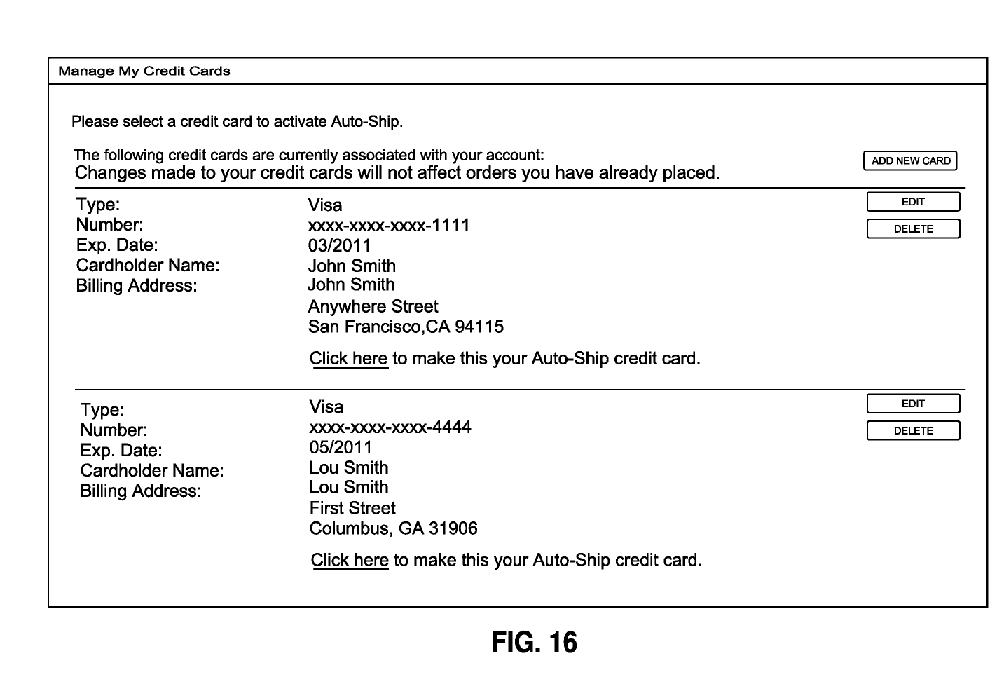

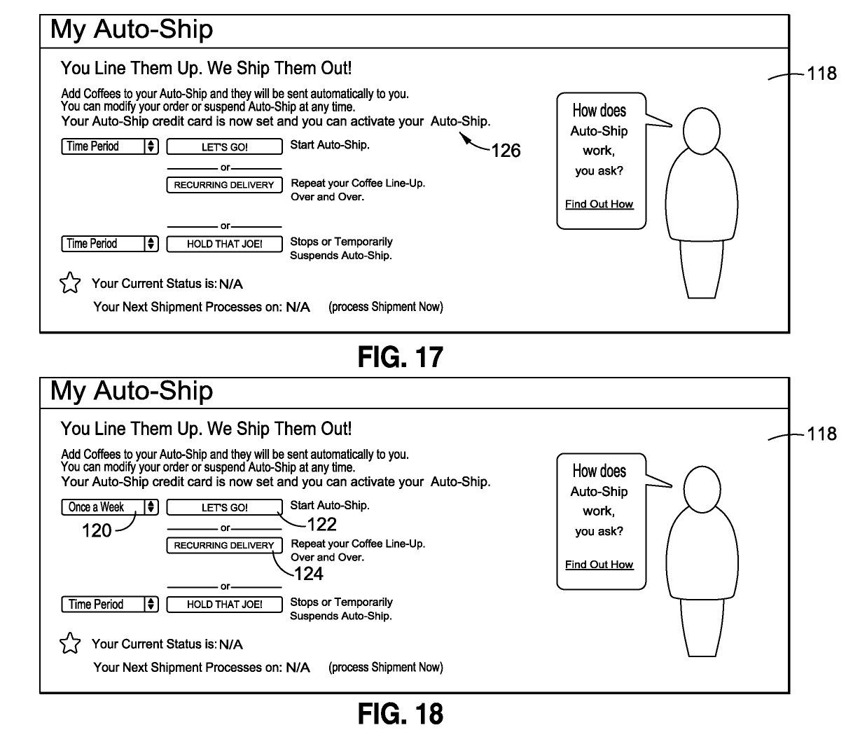

Referring particularly to FIG. 14, there is shown a screen shot of the initial interface page 118. A customer activates the automatic shipment for the first time by selecting a “time period” from the dropdown menu 120 and then clicking either the start button 122 or the recurring delivery button 124. In the example shown in FIG. 15 the dropdown time period button 120 the user has selected “once a week”. The customer is then automatically directed to a linked to a credit card management page, as shown in FIG. 16. On the credit card management page the customer can enter credit card information by “adding a new card” or selecting a preexisting card saved within the system to use as the automatic shipment credit card. The user has selected the automatic shipment credit card the webpage is linked back to the interface page 118 as shown in FIG. 17. A line now appears in the interface page that states “your auto-ship credit card is now set and you can activate your auto-ship”. Again as shown in FIG. 18, the time period selected for dropdown menu is once a week. Other time periods may include any time period set by the web administrator. In the example of FIG. 18 the delivery is set based on weekly periods. For example, the user may select once a week, every two weeks, every three weeks or every four weeks. To activate the auto shipment the customer selects either the start button 122 or the recurring delivery button 124.

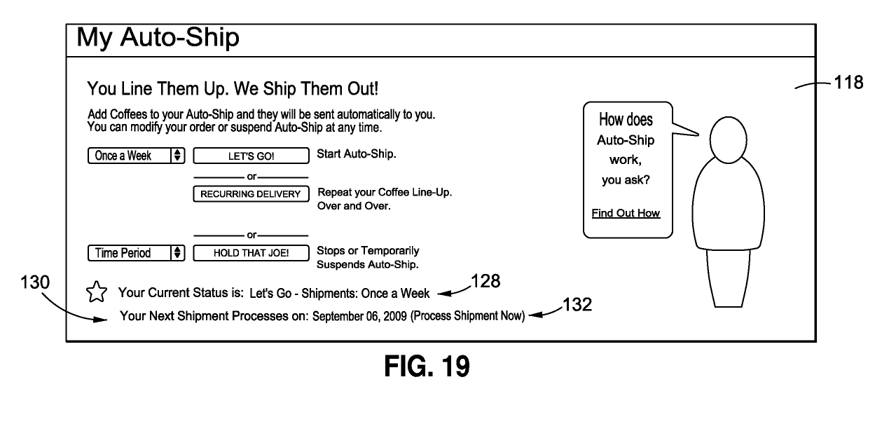

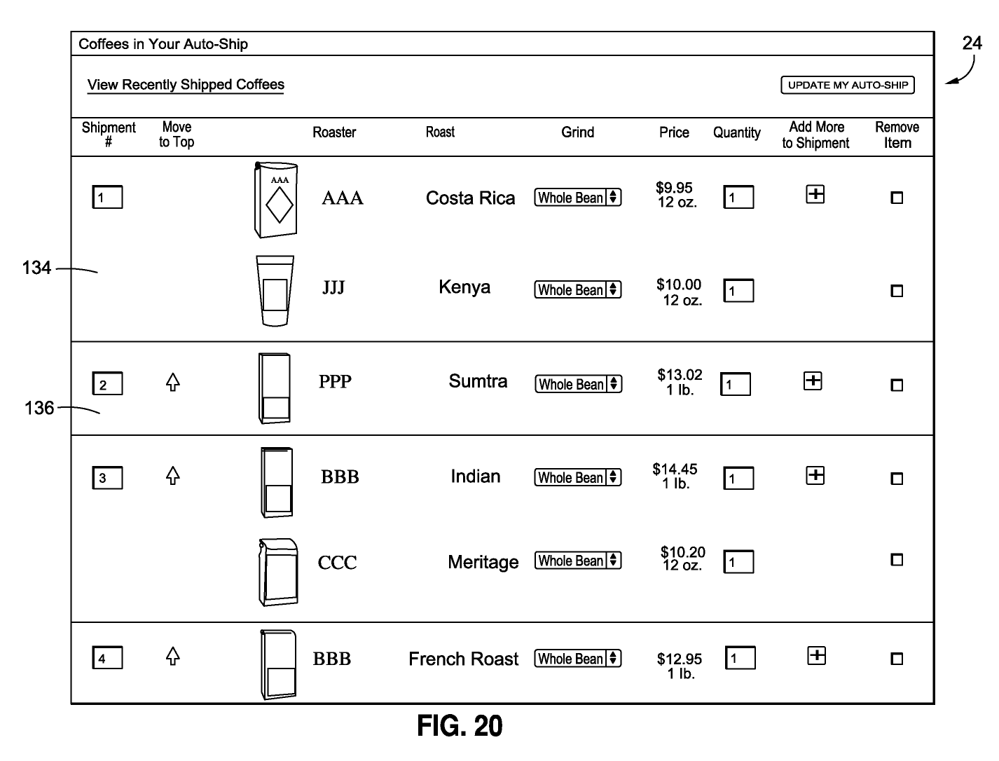

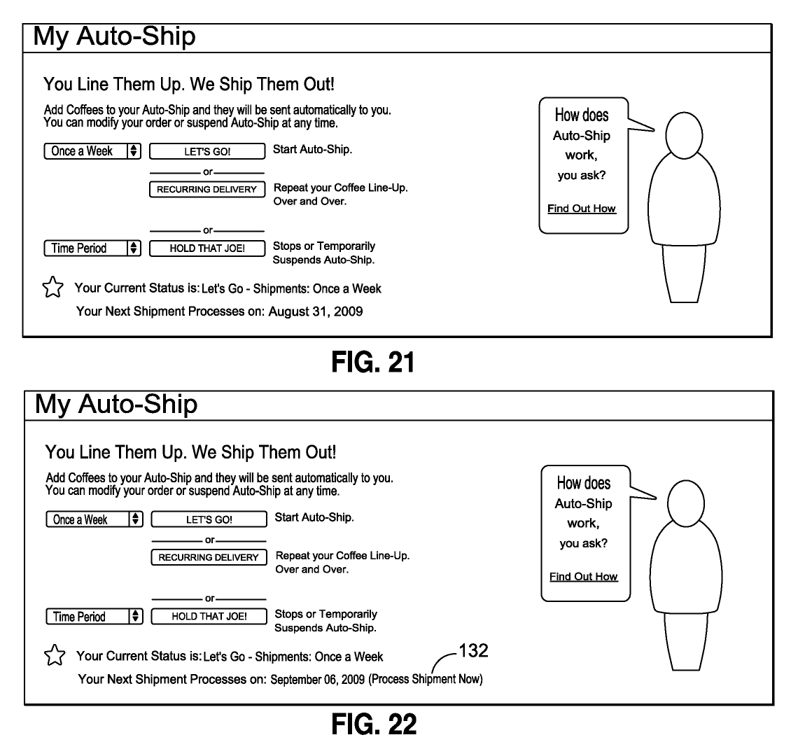

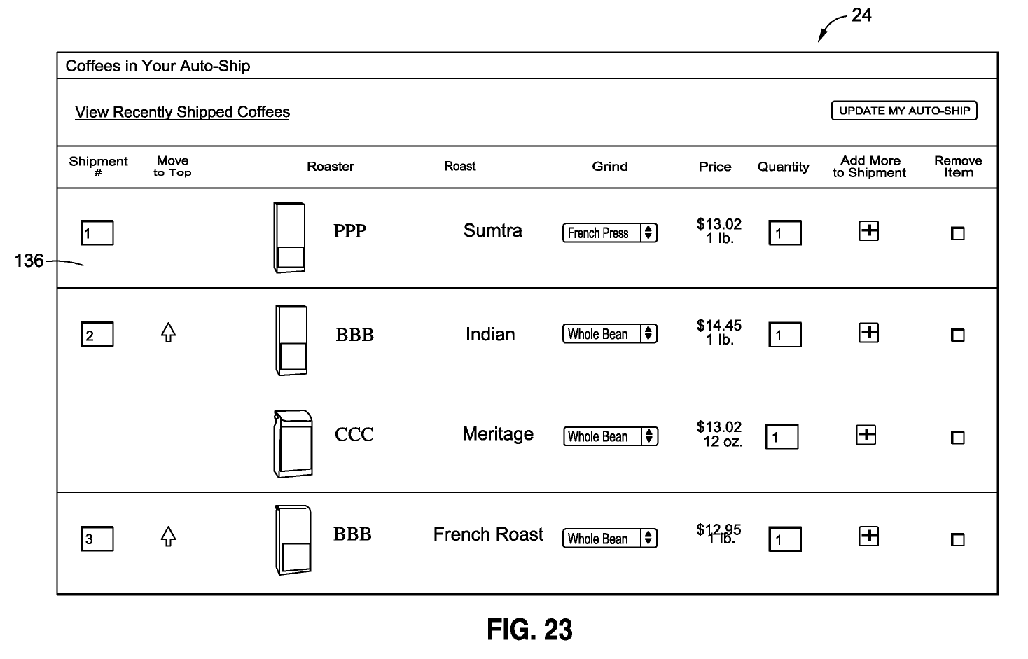

Once the user activates the start button 122 on the interface page 118, if the queue 24 is then empty, the auto-ship interface page 118 indicates “hold that Joe” suspending and stopping that automatic shipment. However, once the start 122 button is activated the customer can manipulate the order, the quantity, the attribute, the amount of items in the shipment as well as delete items in the shipment. An example of an interface page 118 after the automatic shipment has been activated and the use has set the time period of one week is shown in FIG. 19. The status line 128 now reads “shipments once a week” and the shipment process line 130 indicates when the next shipment will process. In the example of FIG. 19, the interface 118 specifies a date one week from the date of activation. Although the example provides for one week from the date of activation, the administrator can pick any particular time period that is suitable. The user may additionally select the “process shipment now” button 132 that processes the shipment on that day. FIG. 20 is representative of a shipment queue including a plurality of items. FIG. 21 is an example where the user has selected “process shipment now” button (not shown) and the stated shipment date is the day that the button was selected. The automatic shipment order processes on the same day, and in the embodiment of the present invention is executed approximately 11:59 pm. Although the example provides shipment at 11:59 pm, the order processing time can be set as the administrator chooses. An automated program initiates at a specified time on the server so that all orders from customers are placed in a supplier order queue (not shown) at the back end of the website. The orders can be placed in an order queue for one vendor or orders are placed in multiple vendors for drop shipping from various points or origins or alternatively for a single vendor with multiple warehouse with various points of origin. When the order executes it is removed form the queue 24 and the next order moves up to the position no. 1, all orders are moved up in position. Referring to FIGS. 20 and 23 jointly, the queue 24 has been modified by execution of the auto-ship of the order cart 134 is removed from the queue 24 as shown in FIG. 23 and the shipment cart 136 as shown in FIG. 20 moves to position no. 1 in FIG. 23. At any point in the process as shown in FIG. 22 the user can select process shipment now 132 and reset the next shipment date to the date the process now button 132 has been selected.

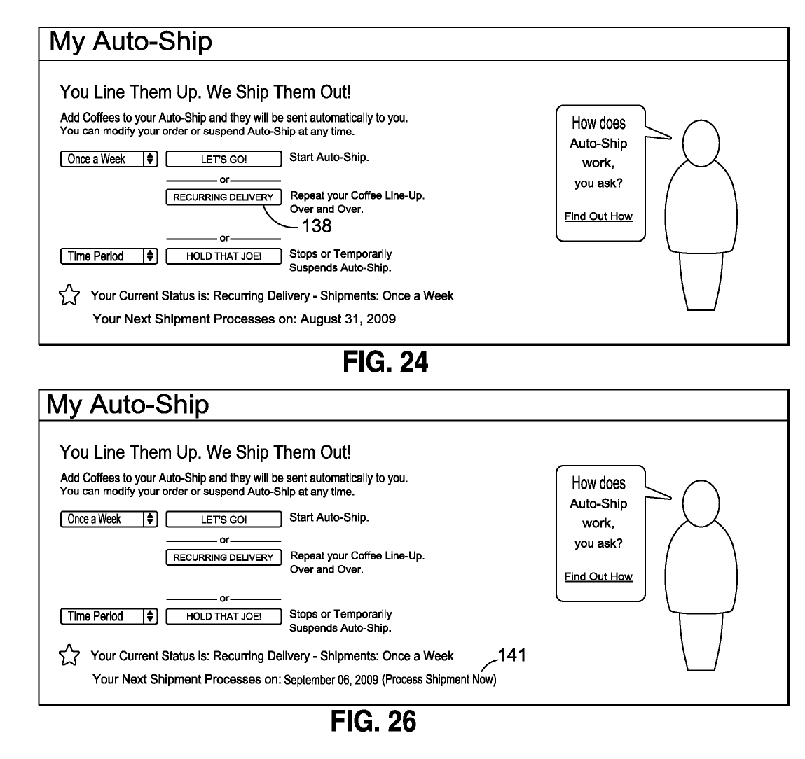

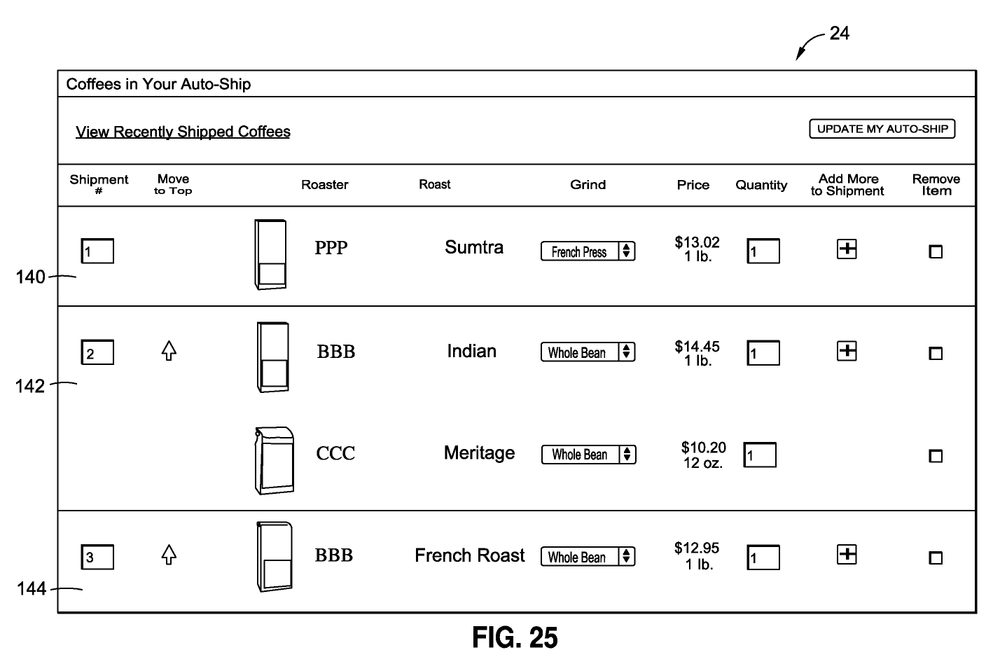

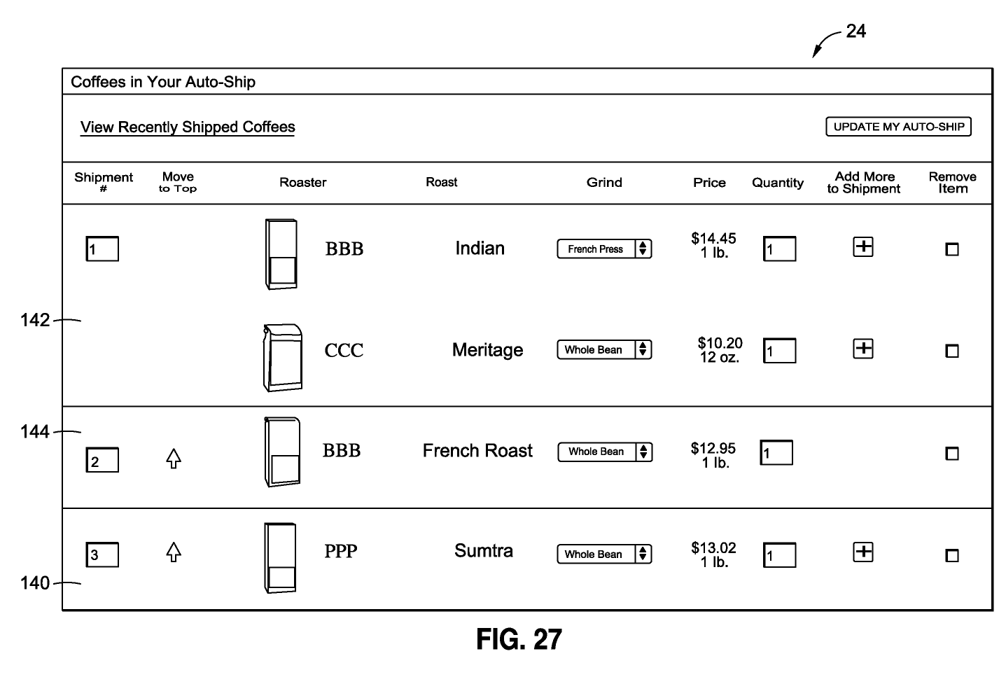

The user can also select the recurring delivery option button 138 as shown in FIG. 24. This function repeats the order of shipments from the beginning of the queue 24 to the bottom of the queue 24 repeatedly until the recurring delivery is deactivated. An example is shown in FIGS. 25, 26 and 27 where order cart 140 is placed within the queue with orders 142 and 144. Once the order cart 140 is executed using the reoccurrence function, as shown in FIG. 27 the other carts 142 and 144 are moved up in priority, the last executed order 140 is then reinserted to the bottom of the queue 24. In this regard, the order sequence repeats until it is deactivated. After the first shipment is activated and processed in the recurring delivery, a user can select the process shipment now button 141 to reset the shipment date to “present”, changing the day of the week for processing.

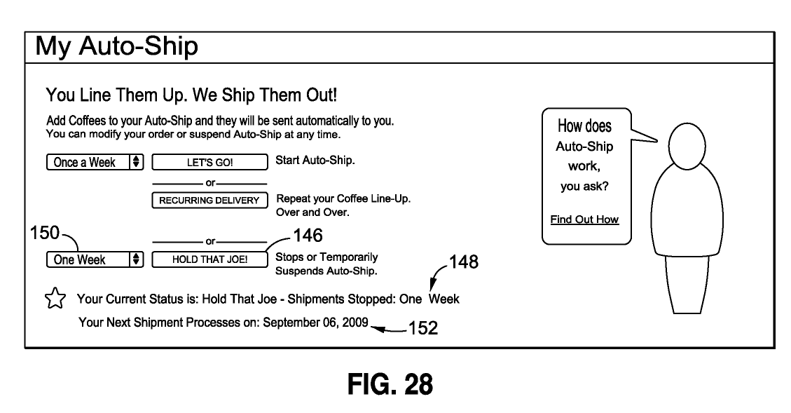

Furthermore, a user can suspend the auto shipment as demonstrated in FIG. 28 for a temporary amount of time or indefinitely by selecting the hold button 146. The status line 148 will show that shipments have been stopped by one week where the user has selected a one week time interval in the dropdown button 150. The process shipment date then resets as shown in the process line 152. After the hold lapses, delivery resumes based upon the last setting the customer had prior to initiating the hold.

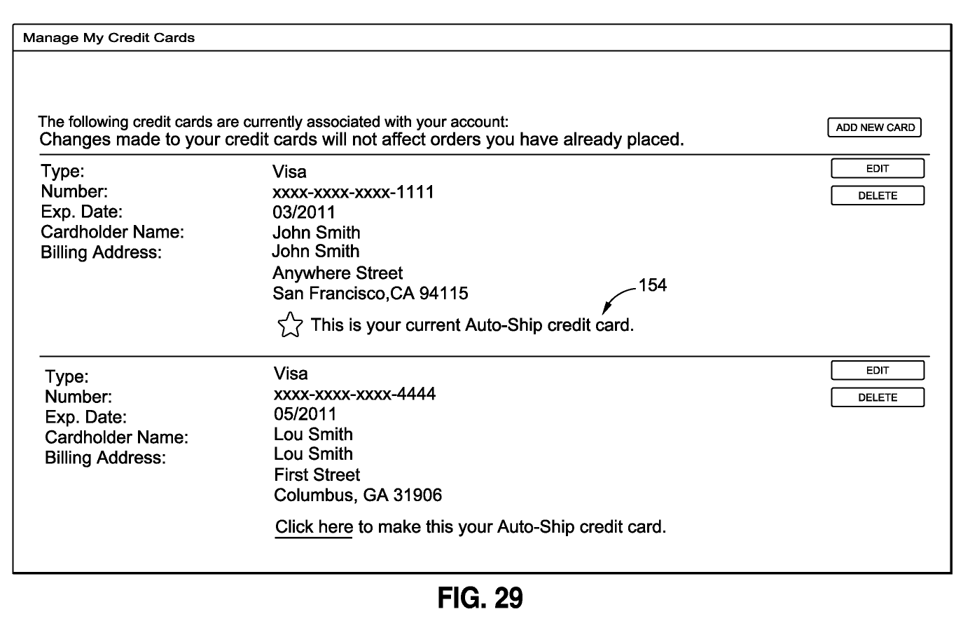

Referring particularly to FIG. 29, an example is shown which demonstrates in the credit card management interface. As noted on line 154, the credit card that is used for the automatic shipment is identified.

When a product is no longer available, the product is removed at the administrative level and all customer queues that have a product within a shipment cart are updated. In this regard, the product is removed and the next product in the automatic shipment queue moves up in priority within the queue. If the queue is empty at the point when the product is removed, the automatic shipment process is suspended. It is contemplated that the present invention may provide a mechanism for notifying a customer through provided customer information when a product is removed from the product queue. This may provide the user with an opportunity to substitute a product, to suspend or delay shipment.

Once each day, the present invention contemplates an automatic execution of orders that are scheduled on a particular date at the top of each users queue, and the orders are placed in an order queue at the supplier backend of the website (not shown). If there are multiple drop shipping vendors or warehouses with various points of origins, those queues on the back end of the website are allocated to the relevant orders for those queues. This may be based on a numeric order system that identifies each vendor or vendors and warehouses with queue numeric identifier at to the direct orders in the supplier queue. Once placed in the supplier queue, orders are then fulfilled by the vendors.

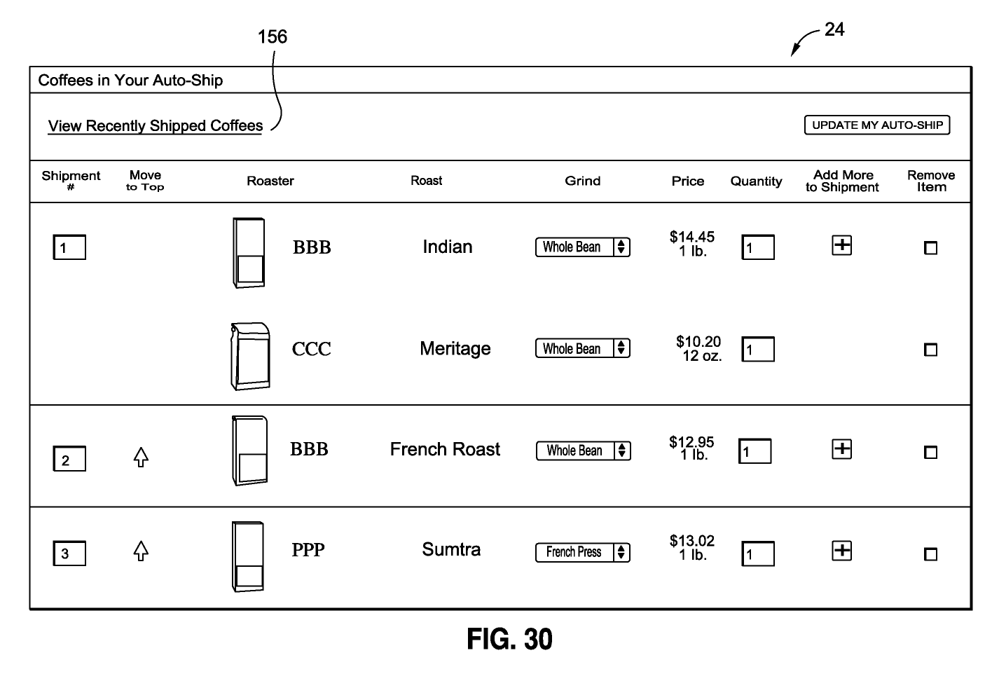

A user may additionally view a recently shipped orders. In the queue 24 as shown in FIG. 30, a user may click the link 156 to identify recently shipped items. A tracking number is contemplated to be associated with the order and the customer can link to information to track the order.

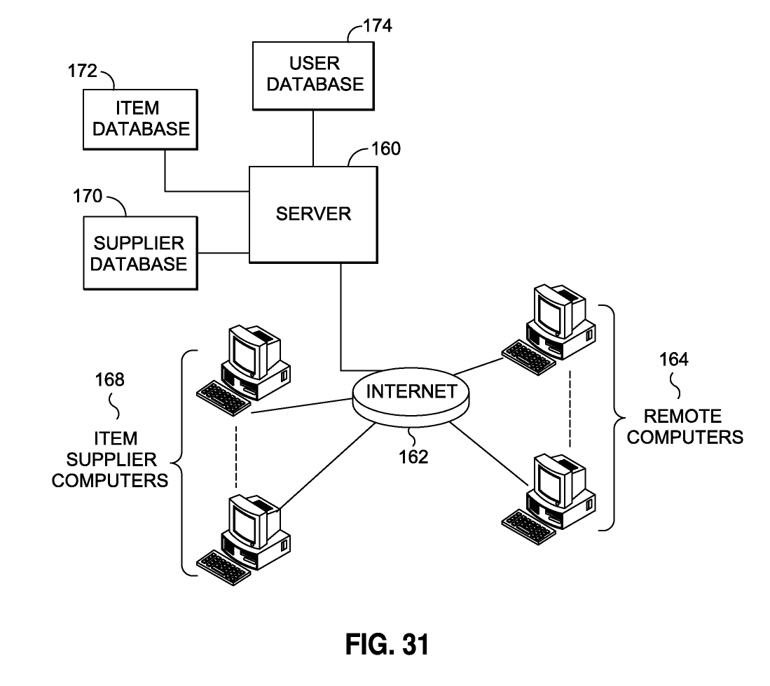

Referring particularly to FIG. 31 there is shown a general block diagram of the system of the present invention. More particularly, a website server 160 is provided which is accessible via the Internet 162. A plurality of remote computers 164 interconnected to the Internet 162 which may access the web server 160. Furthermore, a plurality of item supplier computers 168 additionally access the server 160 via the Internet. The server includes a database of item suppliers 170 and may also include various items available for purchase stored in item database 172. A plurality of users from remote computers 164 through the website server create accounts and the user information is stored in the user database 174. In operation, a user of the website which employs this system and method of the present invention accesses via a remote computer 164 through the Internet 162 through the server 160. The user logs into the server 160 and access is gained through information verified through user database 174. The user then can shop for items made available via web pages on the server 160 populated by the items for sale from the item database 172. Information in the item database 172 is supplied by item suppliers through an item supplier computer 168 through the Internet 162 through server 160. The information regarding items are stored in item database 172. Once a user selects an item to be purchased through the server 160, an order is stored within the user database 174. Each day, a program is executed on the server 160 to identify orders to be processed that day from the user database 174. Orders are then included within the supplier database for fulfillment by the suppliers. Each day the suppliers through computers 168 access the server 160 to view orders that are supplied from the supplier database. On the supplier database 170 also verifies that log on and secure access by the supplier. The suppliers then fulfill the orders and ship items to the users of the remote computers 164.

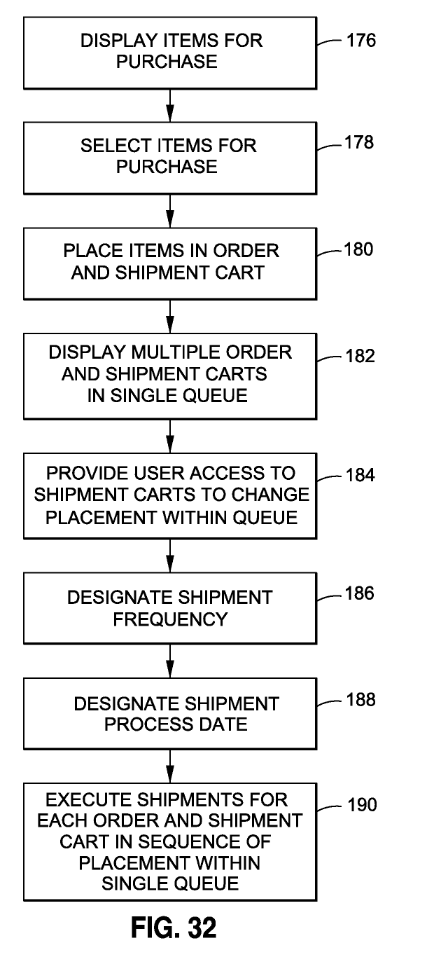

Referring particularly to FIG. 32, there is shown a flowchart that identifies generally the process of the system and method of the present invention. In the first step, 176 items are displayed for purchase on a website which is accessible via the user over the Internet. Once the user identifies a particular product, the customer selects an item for purchase 178 in the next step. In the next step, the selected items are placed into an ordering shipment cart 180, and the ordering shipment cart includes data such as the attributes of a product, the particular product, the price and quantity. The use may select multiple ordering shipment carts for dates of different delivery, and the user may place each of those order and shipment carts into a single queue in step 182. The user cannot only view each of the carts within a single queue, the user has access to each of the shipment carts to change placement within the queue in step in step 184. As such, the user may place the shipment cart in order of priority, or combine shipment carts and manipulate the queue as the user believes is appropriate. The user then designates the shipment frequency in step 186 and each of the shipment carts are then executed according the time frame selected by the user. For example, if the use selects a time period of one week, and the user has identified five shipment carts placed within the queue, each of the shipments executed once a week for a period of five weeks. As such, shipments are executed for each order and shipment cart in the sequence of placement within the queue in step 190.

Referring to the code that may be used to in the system and method of the present invention, the following is representative to adding coffee to the automatic shipment:

url:/auto_ship/add/5?grind=1
5=product_id being added to the auto-ship queue
grind=1 this corresponds to the products coffee_grind_id

In adding coffee to the automatic shipment, in the above example, the program first checks if the product being added is active, if not, the user is sent back to the page they came from. Further the program pulls the customer's session identification (“session_id”) from a cookie called “cart_id.” Because customers do not have to be logged in, the program stores the session_id in the automatic shipment (“auto_ships”) table the session_id so the program can identify the customers automatic shipment queue. Once a customer logs into the system the program will take all the automatic shipments with their current session_id and update the customer_id field to the logged in user's id, therefore tying those auto-ship records to the customer. The program saves the auto-ship record and if successfully saved then redirects the customer back to the auto-ship page and jumps to the bottom of the page where the new item has been added.

A shipment in the queue can have one or more items. The first item is the parent and all other items are children of the parent coffee. The first information to print out with regard to the queue is query out all the parent coffees (parent_id=0). The program then loops through each parent “print out the row” data. After the information prints each parent, the program will check if that parent has any children, and if so, the program will also print its children out directly under the parent, making up all the products on the shipment.

As the program loops it through, printing out the parent and children rows for each shipment, it will also make some javascript calls enabling the dynamic drag and drop sort capabilities. After each parent row it will call AutoShip.makeDraggable( ) and AutoShip.addParent( ) and after each child row it will call AutoShip.makeDraggable( ) and AutoShip.addChild( ). The addParent and addChild is so the AutoShip class can track the order of the products and where they are in the sort tree. The makeDraggable calls makes the row draggable to be able to drop onto the area exposed when you click the plus sign on the shipment “Add More to Shipment”. For reach shipment there is a hidden row that is a drop area for combining shipments and is made so via the call AutoShip.makeDroppable( ). Lastly there is a call to AutoShip.makeSortable(“qtable”) which makes all the shipment rows meaning the parent and children rows as one unit sortable up and down.

For combining shipment items when the plus sign icon 98 (see FIG. 9) for the shipment is selected a div 100 is shown that is a drop area for any of the individual item rows to drag and drop onto. To move an item to another shipment a customer must click and hold the item icon (the item icon is the handle, since the whole row itself is the handle for the drag sorting) and drag and drop on the drop area for the shipment. When dropped, the program will update the dropped coffee to have the parent_id of the parent coffee for that shipment and the shipment number of that shipment.

A user can also sort the shipment queue by dragging. When user places a mouse over a row, the user can click and hold, then the user can drag the row vertically and when dropped it will be inserted into the queue at the spot dropped. Behind the scenes, the program does an ajax call to /auto_ship/update_queue with all the form data just as if the Update My Auto-Ship button 96 (see FIG. 8) was clicked.

When changing the Shipment number via the text box 94 (See FIG. 8) it will not auto save the change. You must press the Update My Auto-Ship button 96 for the changes to be saved.

When the update button 96 (see FIG. 8) is selected it will take the queue and post to /auto_ship/update_queue. In update_queue it will call order_queue first. It sorts the queue according to the numbers that are in the shipment number text box 94 in the queue. In sort_by_shipment_number it has two functions: sort_on_shipment_number and sort_on_shipment_number2 which will sort the shipments up or down as callback functions to uasort. After the queue is in the correct order program will loop through the queue and update the grind, quantity, shipment number, and delete rows if checked to remove item. After the program has performed looping through the rows it will redirect back to the auto-ship page reloading it with the updates.

The program performs a timing function every twenty four hours. The program performs a cron job that is setup to run every night at 11:59 pm. It will query from the customers table all the where auto_ship_next_run=‘{$today}’. Once the program has a list of customers to run, the program will loop through those customers and make sure that they have an Auto-Ship credit card and default address set. Next the program will grab the customer's shipment #1 and run any promo's and specials against it, get the shipping costs, and then generate the order. After that it will depending on the Auto-Ship settings:

1. Let's Go, delete shipment #1 and bump all the others up.

2. Recurring Delivery, put shipment #1 to the bottom of the queue and bump everything up 1.

3. Hold that Joe, will reactivate the Auto-Ship to what it was before they put it on hold, Let's Go or Recurring Delivery.

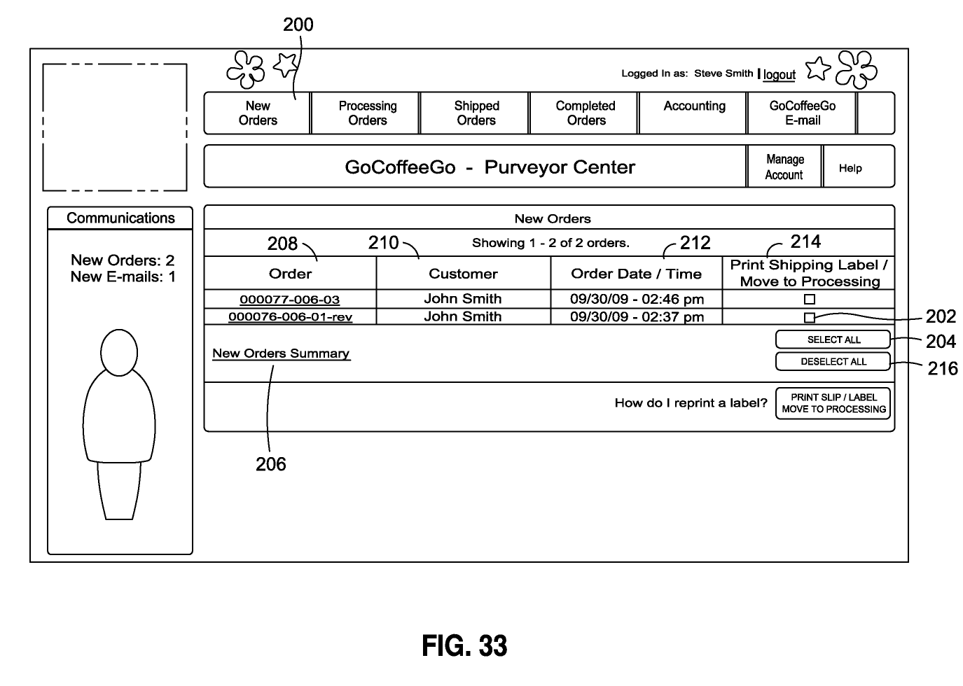

Referring particularly to FIGS. 33 through 36, there is shown screenshots of interfaces for use by suppliers on the backend of the website. Item suppliers who wish to offer their products on the website upload item information to the website which is stored in a database interconnected to the website server. Alternatively, the website administrator can upload or input item information. The website administrator decides to display the arrangement of the products on the website, accessible to the consumers on the front end of the website. Once an order is entered by a customer, the order information is conveyed to the backend supplier side of the website which is accessible by the supplier to enable the supplier to fulfill the order. Once payment is received by the customer, the website administrator may charge a commission on the items sold and transfer any funds received for payment of the item to the supplier.

More specifically with respect to FIGS. 33 through 36, FIG. 33 is representative of a screenshot of new orders that have been received with respect to a particular supplier. In the example provided, the supplier user can click on new orders button 200 to view the new orders that have been received for this particular provider. As discussed above, at the end of each day the program within the server searches all of the purchases and shipment queues 24 for orders and shipments coming due on that day. Once identified, the server transmits the information to a particular supplier as a new order and can be viewed the interface page as shown in FIG. 33. In order to fulfill the orders, the supplier can click a box 202 to fulfill a particular order. In addition, the user may click on box 204 to select all the items. The user can also select new order summary link 206 that provide a more detailed report to the supplier. The screenshot of FIG. 33 shows four columns, mainly the order column 208 which identifies the particular order number, the customer column 210 that provides the name of the customer, the order, date and time column 212 which provides information regarding the date the order was placed and the time that the order was placed, and the processing column 214 that allows the supplier to select certain items for processing. The move to processing button 216 is provided to the supplier which is selected after the supplier has designated the particular boxes in column 214 or has selected all boxes by selecting button 204. Upon selecting box 216 the selected orders are immediately moved into the processing mode, and a print slip label is forwarded to the supplier's printer. A UPS label or other shipment label is produced on the printer so that the supplier can apply the label to a shipping container to ship the item. A tracking number created upon order execution is associated with the label and shipment.

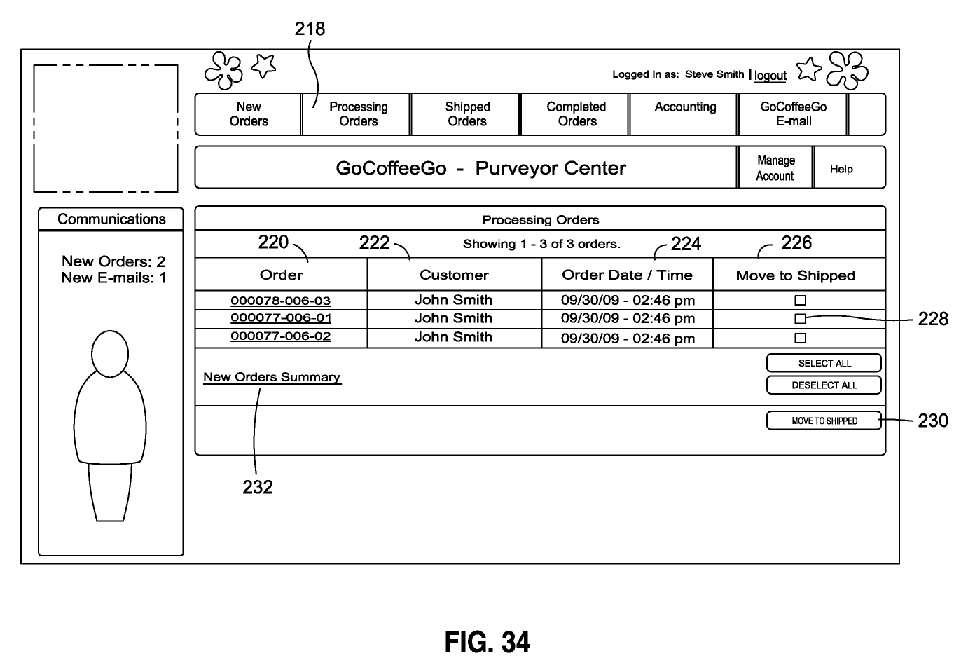

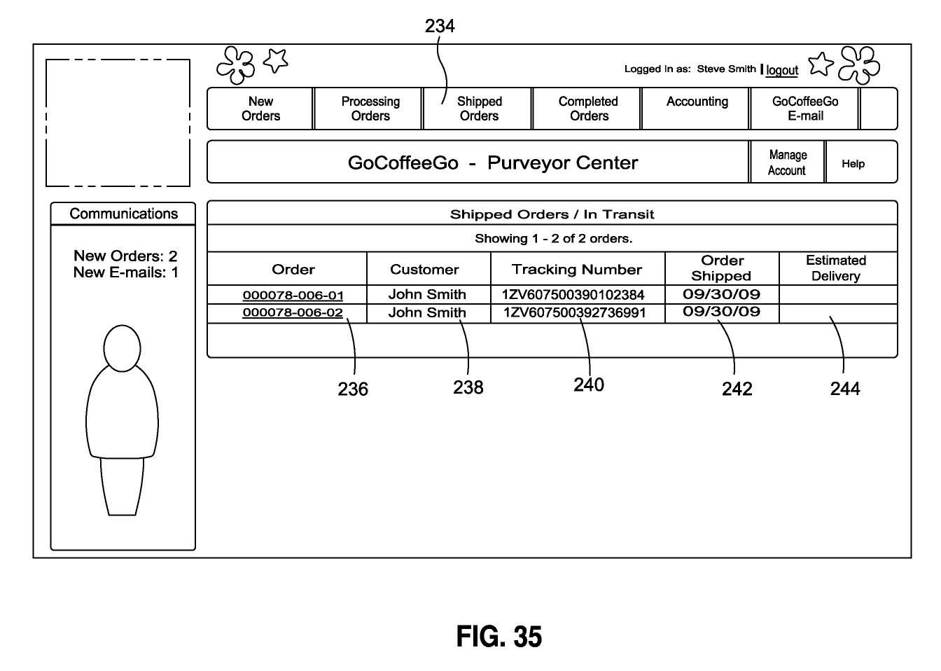

Referring to FIG. 34, supplier user can select button 218 to identify the processing orders screen. With this interface the user can identify which products have been shipped and therefore indicate to a customer and/or the website the status of a particular order. For example, once an order has been shipped, the supplier checks box 228 under the shipment column 226 and selects a move to ship button 230. That particular order will then be designated as shipped. The shipped item is cross referenced to a tracking number that was generated when the user selected button 216 as shown in FIG. 33. On the screen is shown in FIG. 34 an order column 220 is shown, with a customer column 222 and the order, date and time column 224. The user can select link 232 to review a report of processed orders. Referring particularly to FIG. 35, there is shown a partial supplier user interface for identifying shipped orders. The supplier selects shipped orders 234 which generates the screen as shown in FIG. 35. The user can view the shipped order and includes order column 236 including information about a particular order number, the customer column which identifies the customer by name, a tracking number column 240 which identifies the shipment tracking number, the order shipped column 242 which identifies the date of shipment, and the estimated delivery column which identifies the estimated delivery of a shipment.

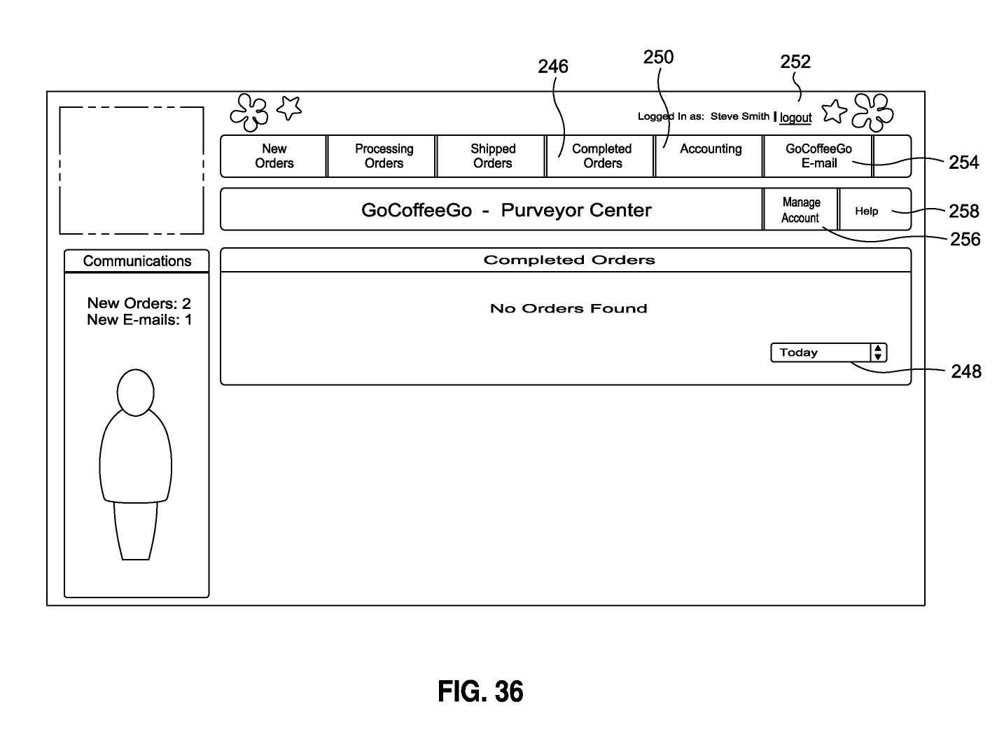

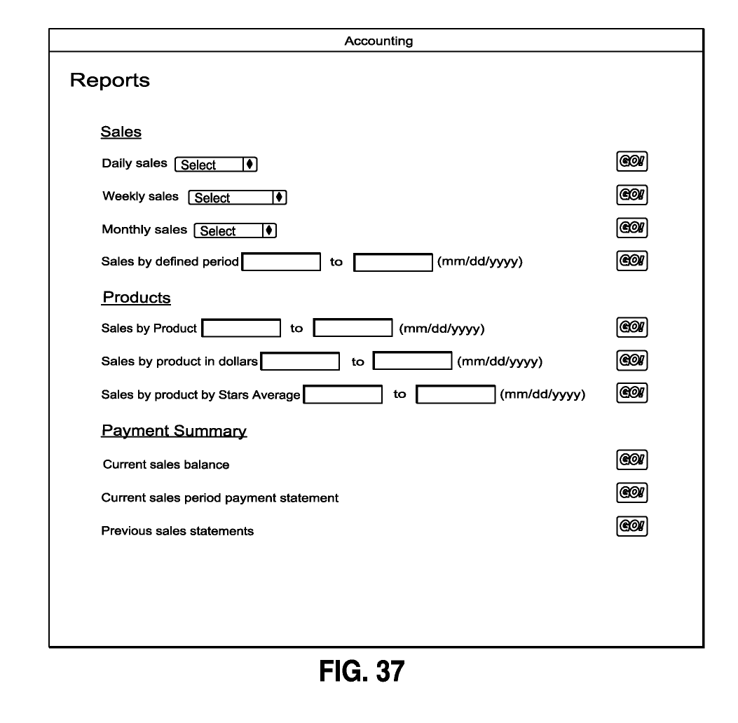

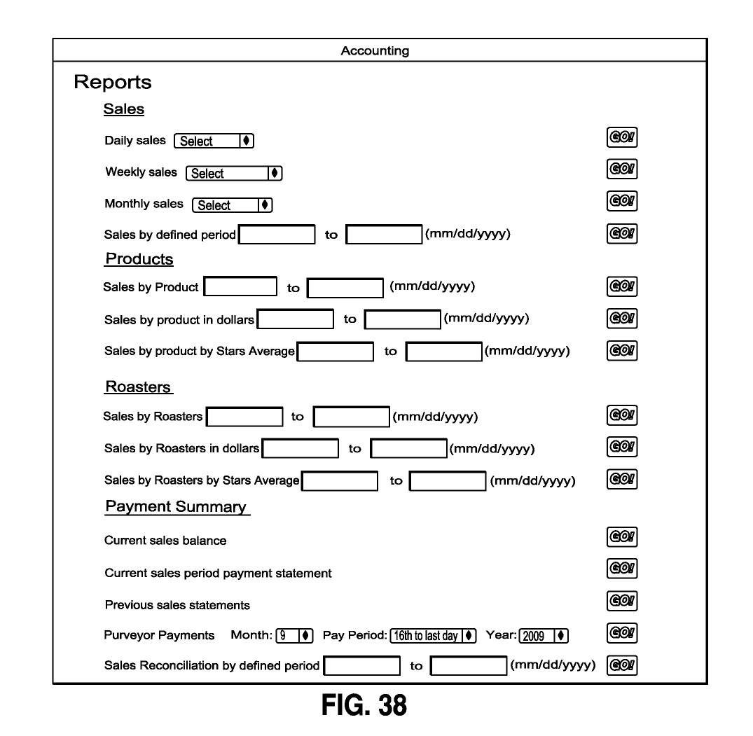

Referring particularly to FIG. 36, there is shown the supplier user interface screenshot when the user has selected completed order button 246 to generate the screen. The user can view completed orders on the date selected. The user can select additional time periods to view by clicking on the drop down menu button 248. The user can also select button 250 to deal with accounting issues related to the supplier account, including generating reports on sales, payment owed, daily sales, weekly sales, month sales, sales by defined period as well as others. (See FIG. 37). A similar, but more detailed interface is available on the administrative side of the web servers including additional information such as total sales of all roasters (suppliers), as shown in FIG. 38. In both FIGS. 37 and 38 sales by stare means sales by customer ratings. Referring to FIG. 36. The user client click on item 254 to send communications within the website. The user can also select manage account on item 256 and input pertinent information regarding security access levels stored in the supplier database of the website server. The help button 258 is provided to advise the supplier user on the operation of the supplier end of the website.

The above description is given by way of example, and not limitation. Given the above disclosure, one skilled in the art could devise variations that are within the scope and spirit of the invention disclosed herein, including various ways of implementing the system and method. Further, the various features of the embodiments disclosed herein can be used alone, or in varying combinations with each other and are not intended to be limited to the specific combination described herein. Thus, the scope of the claims is not to be limited by the illustrated embodiments.

1. A computer implemented method of ordering and purchasing items through a network, said network comprising at least one server computer capable of being in electronic communication with at least one remote computer, said method comprising:
providing a database of items to be purchased;
displaying on said at least one remote computer a listing of items for purchase from said database;
providing graphics to allow a user to select at least one item to be purchased through said at least one remote computer and to store and display information related to said selected items in an order and shipment cart displayed on said at least one remote computer;
graphically providing on said at least one computer a plurality of order and shipment carts for a user to store selected items in separate order and shipment carts, each of said order and shipment carts representing separate orders to be processed;
displaying on said at least one computer a plurality of order and shipment carts in a graphically displayed purchase queue;
providing graphics within said purchase queue to allow a user to place the selected order and shipment carts in a desired hierarchy within said purchase queue representing the sequence in which the order represented by each order and shipment cart will executed; and
providing graphics within said purchase queue to allow a user to select a time interval between the execution of orders in sequence represented by placement of the order and shipment carts within the purchase queue and wherein each said order will be executed automatically in sequence based upon placement within the purchasing queue and according to selected time interval.

2. The computer implemented method of ordering and purchasing items of claim 1 further comprising the step of requesting a user to designate a date to execute the first order represented by the order and shipment cart in the first placement of the purchase queue.

3. The computer implemented method of ordering and purchasing items of claim 1 further comprising the steps of:
collecting payment information and associating said payment information with said purchase queue; and
collecting delivery address information and associating said address information with said purchase queue.

4. The computer implemented method of ordering and purchasing items of claim 1 wherein components of said network communicate via the internet.

5. The computer implemented method of ordering and purchasing items of claim 1 wherein displaying and providing graphics is effected by displaying an HTML document provided by said at least one server.

6. The computer implemented method of ordering and purchasing items of claim 1 wherein the content of a user's purchase queue is stored in a user database and associated with said user.

7. The computer implemented method of ordering and purchasing items of claim 6 wherein said user is provided access to said user database and information provided in a previously stored purchase queue.

8. The computer implemented method of ordering and purchasing items of claim 1 wherein said purchase queue provides the user with the option of adding order and shipments carts to be included within the purchase queue.

9. The computer implemented method of ordering and purchasing items of claim 8 wherein said purchase queue provides the user with a graphical interface that allows the user to manipulate visual placement of the order and shipment carts within the purchase queue to establish order of processing.

10. The computer implemented method of ordering and purchasing items of claim 1 wherein said server provides secure access by at least one supplier computer to provide information to include in said database of items to be purchased.

11. The computer implemented method of ordering and purchasing items of claim 1 wherein said server sends instructions to a supplier computer in communication with said network to fulfill an order request.

12. The computer implemented method of ordering and purchasing items of claim 1 further comprising a further step of providing an option to the user to authorize the reoccurrence of the execution of orders in the sequence represented by the placement of the order and shipment carts within the purchasing queue.

13. The computer implemented method of ordering and purchasing items of claim 1 further comprising a further step of providing an option to the user to authorize the suspension of the execution of orders in the sequence represented by the placement of the order and shipment carts within the purchasing queue.

14. The computer implemented method of ordering and purchasing items of claim 13 further comprising a further step of providing an option to the user to authorize the resumption of the execution of orders after suspension, in the sequence represented by the placement of the order and shipment carts within the purchasing queue.

15. The computer implemented method of ordering and purchasing items of claim 1 comprising the further step of displaying each of said order and shipment carts as graphical units within the purchasing queue display, said graphical units capable of on screen manipulation on said at least one remote computer to allow a user visually place the graphical units in a desired hierarchy within the purchasing queue.

16. The computer implemented method of ordering and purchasing items of claim 1 comprising the further step of permitting a user to combine two or more order and shipment carts within the purchasing queue display to form an order and shipment cart that combines the items from each of the combined carts.
